(19) United States
(12) Patent Application Publication
(10) Pub. No.: US 2017/0239699 A1
(43) Pub. Date: Aug. 24, 2017

(54) Chemical Oxidation and Biological Attenuation Process for the Treatment of Contaminated Media

(71) Applicant: Innovative Environmental Technologies, Inc., Pipersville, PA (US)

(72) Inventors: Michael Scalzi, Doylestown, PA (US); Antonis Karachalios, Hatfield, PA (US)

(21) Appl. No.: 15/250,907

(22) Filed: Aug. 29, 2016

Related U.S. Application Data
(63) Continuation-in-part of application No. 14/268,629, filed on May 2, 2014, now Pat. No. 9,427,786.
Application No. 14/268,629 is a continuation-in-part of application No. 13/891,934, filed on May 10, 2013, now Pat. No. 9,126,245.

(51) Int. Cl. B09C 1/08; C02F 3/28; C02F 3/00; C02F 1/72

(52) U.S. Cl. CPC B09C 1/08; C02F 1/722; C02F 3/28; C02F 3/006; C02F 2101/363

(57) ABSTRACT

Chemically oxidizing a wide range of targeted contaminants in soils, sludges, groundwater, process water, and wastewater and assisting in the eventual (over time) biological attenuation of the contaminants utilizing persulfates activated by trivalent metals, such as ferric iron. The use of trivalent metal activated persulfate results in a chemical oxidation process that yields degradation compounds which facilitate further attenuation via biological processes.

### PRIORITY

This application is a continuation-in-part (CIP) of, and claims priority to, U.S. application Ser. No. 14/268,629 filed on May 2, 2014 (to issue as U.S. Pat. No. 9,427,786 on Aug. 30, 2106). application Ser. No. 14/268,629 is a CIP of, and claims priority to, U.S. application Ser. No. 13/891,934 filed on May 10, 2013 (issued as U.S. Pat. No. 9,126,245 on Sep. 8, 2105). application Ser. No. 14/268,629 and 13/891,934 are herein incorporated by reference.

### FIELD OF INVENTION

The present invention relates to the in-situ and ex-situ oxidation of organic compounds in soil, sludge, groundwater, process water, and wastewater. More specifically, the present invention relates to the oxidation and biological attenuation of volatile and semi-volatile organic compounds, pesticides and herbicides, and other recalcitrant organic compounds in soil and groundwater using non-chelated trivalent metal activated persulfate, with the use of iron oxides such as but limited to hematite and magnetite.

### BACKGROUND

Chlorinated solvents and petroleum hydrocarbons, including polyaromatic hydrocarbons are compounds characterized by their toxicity to organisms at higher concentrations and are widely distributed in oil contaminated soils and groundwater.

Halogenated volatile organic compounds (VOCs), including chlorinated aliphatic hydrocarbons (CAHs), are the most frequently occurring type of contaminant in soil and groundwater at Superfund and other hazardous waste sites in the United States. The U.S. Environmental Protection Agency (EPA) estimates that cleanup of these sites will cost more than $45 billion (1996) over the next several decades.

CAHs are manmade organic compounds. They typically are manufactured from naturally occurring hydrocarbon constituents (methane, ethane, and ethene) and chlorine through various processes that substitute one or more hydrogen atoms with a chlorine atom, or selectively dechlorinate chlorinated compounds to a less chlorinated state. CAHs are used in a wide variety of applications, including uses as solvents and degreasers and in the manufacturing of raw materials. CAHs include such solvents as tetrachloroethene (PCE), trichloroethene (TCE), carbon tetrachloride (CT), chloroform (CF), and methylene chloride (MC). Historical management of wastes containing CAHs has resulted in contamination of soil and groundwater, with CAHs present at many contaminated groundwater sites in the United States. TCE is the most prevalent of those contaminants. In addition, CAHs and their degradation products, including dichloroethane (DCA), dichloroethene (DCE), and vinyl chloride (VC), tend to persist in the subsurface creating a hazard to public health and the environment.

Benzene, toluene, ethylbenzene, and xylenes (BTEX) are characterized by their toxicity to organisms at higher concentrations, and are widely distributed in oil contaminated soils, groundwater, and sediments as a result of relatively high aqueous solubility compared to other components of petroleum. The United States Environmental Protection Agency (U.S. EPA) estimates, 35% of the U.S.'s gasoline and diesel fuel underground storage tanks (USTs) are leaking and approximately 40% of these leaking USTs likely have resulted in soil and groundwater contaminations from BTEX. BTEX are volatile and water-soluble constituents that comprise 50% of the water-soluble fraction of gasoline. The presence of BTEX in groundwater can create a hazard to public health and the environment.

BTEX are readily degradable in aerobic surface water and soil systems; however, in the subsurface environment, contamination by organic compounds often results in the complete consumption of available oxygen by indigenous microorganisms and the development of anaerobic conditions. In the absence of oxygen, degradation of BTEX can take place only with the use of alternative electron acceptors, such as nitrate, sulfate, or ferric iron, or fermentatively in combination with methanogenesis.

Polychlorinated biphenyls (PCBs) are organochlorine compounds which are mixtures of up to 209 individual chlorinated compounds referred to as congeners. These congener mixtures of chlorobiphenyl (the base chemical) are referred to by different identification systems. PCBs have been commercially produced and sold as pure oil or in equivalent form since around 1929. They are extremely stable compounds with excellent electrical insulation and heat transfer properties. These characteristics have led to their widespread use in a variety of industrial, commercial and domestic applications.

PCBs can be released to the environment in various manners, including but not limited to, from hazardous waste sites; illegal or improper disposal of industrial wastes and consumer products; leaks from old electrical transformers containing PCBs; and incinerating some wastes. Their major disadvantage is that they do not readily break down in the environment and thus may remain there for very long periods of time. They can travel long distances in the air and be deposited in areas far away from where they were released.

While water contamination can occur, many PCBs dissolve or stick to the bottom sediments or attach themselves to organic particles. Similarly, PCBs can be easily attached to soil particles. They can also be absorbed by small organisms and fish and through the food chain can travel to other animals. PCBs accumulate in fish and marine mammals, reaching levels that may be many thousands of times higher than in water.

The U.S. EPA has established permissible levels for chemical contaminants in drinking water supplied by public water systems. These levels are called Maximum Contaminant Levels (MCLs). To derive these MCLs, the U.S. EPA uses a number of conservative assumptions, thereby ensuring adequate protection of the public. In the case of known or suspected carcinogens, such as benzene or PCE, the MCL is calculated based on assumption that the average adult weighs 154 lbs and drinks approximately 2 quarts of water per day over a lifetime (70 years). The MCL is set so that a lifetime exposure to the contaminant at the MCL concentration would result in no more than 1 to 100 (depending on the chemical) excess cases of cancer per million people exposed. FIG. 1 is a table that outlines the MCL figures for various chemical contaminants.

Oxidation is one technology utilized to treat organic contaminants in soils and groundwater. Oxidants utilized in remediation include hydrogen peroxide (H₂O₂). Persulfates (S₂O₈) are strong oxidants that have been widely used in many industries for initiating emulsion polymerization reactions, clarifying swimming pools, hair bleaching, micro-etching of copper printed circuit boards, and total organic compound (TOC) analysis. There has been increasing interest in persulfates as an oxidant for the destruction of a broad range of soil and groundwater contaminants. Persulfates are typically manufactured as sodium, potassium, and ammonium salts. Sodium persulfate (Na₂S₂O₈) is the most commonly used for environmental applications. The persulfate anion is the most powerful oxidant of the peroxygen family of compounds and one of the strongest oxidants used in remediation. By way of example, the standard oxidation reduction potential for persulfate is 2.1 V while it is 1.8 V for hydrogen peroxide (Block et al, 2004).

The activation of the persulfate is limited to activation technologies using divalent iron, ultra violet (UV) light, heat, carbonate, and liquid (hydrogen) peroxide. Each of these activation technologies targets a specific organic range of contaminants. The use of chelated divalent metal complexes to activate persulfate expands the range of contaminants targeted but prevents biological remediation which is a critical step in the remediation process.

Therefore, there is a need in the art for a process of oxidation that targets the full range of contaminants while also fostering biological attenuation of volatile and semi-volatile organic compounds, pesticides and herbicides, and other recalcitrant organic compounds in soils, sediments, clays, rocks, sands, groundwater, and all other environmental media.

### BRIEF DESCRIPTION OF THE DRAWINGS

The features and advantages of the various embodiments will become apparent from the following detailed description in which:

FIG. 1 is a table that outlines the MCL figures for various chemical contaminants;

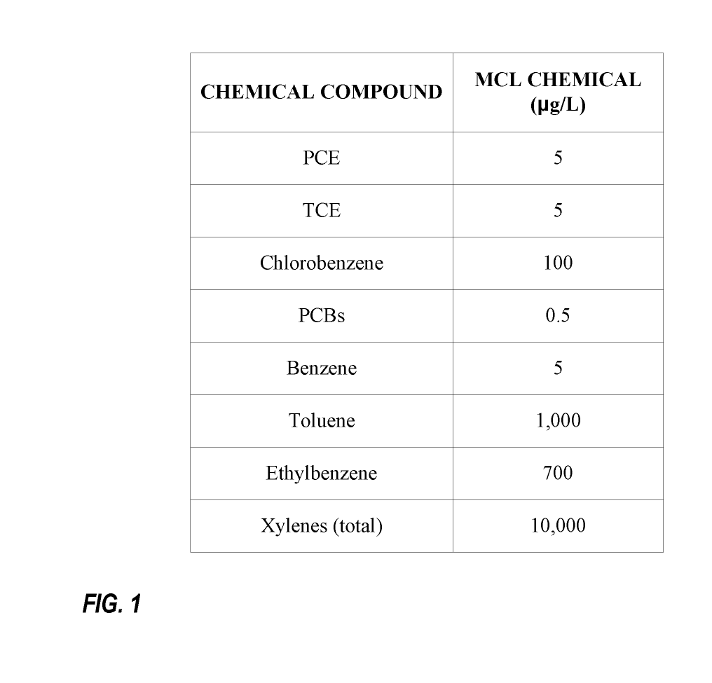

FIG. 2 is a table that shows the elevated oxidation potential of the ferrate (Fe6+) species compared to other oxidants; and

FIG. 3 is table that demonstrates the ORP measurements for all three systems.

### DETAILED DESCRIPTION

The current remediation process includes utilizing trivalent metals to activate persulfate (S₂O₈). The trivalent metals activate the persulfate in order to chemically oxidize a wide range of targeted contaminants and assist in the eventual (over time) biological attenuation of the contaminants. According to one embodiment, the trivalent metal is ferric iron (Fe³⁺). In alternate embodiments, another trivalent metal ion such as manganese (III) or manganic ion (Mn³⁺) may be used. Persulfate activation with ferric iron requires a lower activation energy than thermal activation, which makes iron activated persulfate a more efficient and rapid way of degrading contaminants. The trivalent metals may be applied, either concurrently or sequentially, with the persulfate.

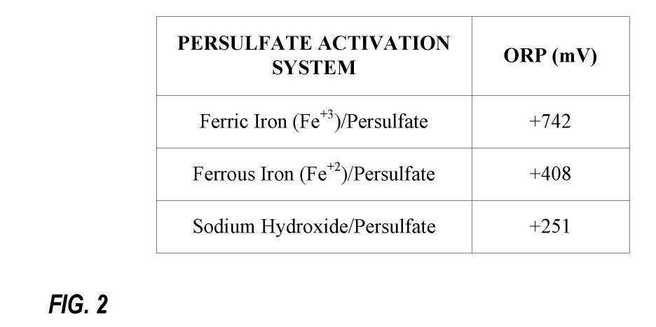

Trivalent metal activated persulfate also has an increased oxidation reduction potential (ORP) over other activation mechanisms. Lab studies were performed to test the changes in ORP upon the activation of persulfate with ferric and ferrous iron species, as well as a caustic activator (Sodium Hydroxide). The experiments were performed at room temperature using deionized (DI) water and a 20% activator to persulfate amount. The materials were mixed for approximately 48 hours and the ORP values were measured. FIG. 2 is table that demonstrates the ferric iron/persulfate system was able to establish higher ORP measurements compared to its other two counterparts.

The contaminants that can be effectively treated with this technology include, but are not limited to, various man-made and naturally occurring volatile hydrocarbons including chlorinated hydrocarbons (e.g., volatile, semi-volatile and non-volatile organic compounds), non-chlorinated hydrocarbons, aromatic or polyaromatic ring compounds, brominated compounds, brominated solvents, 1,4-dioxane, insecticides, propellants, explosives (e.g., nitroaniline trinitrotoluene), herbicides, and petrochemicals. Examples of volatile organic compounds include chlorinated olefins such as PCE, TCE, cis-1,2-dichloroethane and vinyl chloride. Examples of non-volatile organic compounds include PCBs and dichlorobenzene. Examples of non-chlorinated compounds include total petroleum hydrocarbons (TPHs) such as benzene, toluene, xylene, methyl benzene and ethylbenzene, methyl tert-butyl ether (MTBE), tert-butyl alcohol (TBA) and polyaromatic hydrocarbons (PAHs) such as naphthalenepetrochemicals, chlorinated organics, pesticides, energetics, and perchlorates.

The technology may be used for treatment of contaminated soils, sediments, clays, rocks, sands and the like (hereinafter collectively referred to as “soils”), contaminated groundwater (i.e., water found underground in cracks and spaces in soil, sand and rocks), process water (i.e., water resulting from various industrial processes) or wastewater (i.e., water containing domestic or industrial waste, often referred to as sewage).

The activated persulfate effectively oxidizes the targeted contaminant(s) by initially oxidizing the contaminants in the subsurface and then promoting facultative biodegradation (biological remediation) of the contaminants. The introduction of sulfate free radicals allows for a long-lived oxidation, which further extends by utilizing the radical residual and stimulating the biological mineralization of the targeted contaminants.

During the chemical oxidation phase, sulfate free radicals attack the aromatic hydrocarbon bonds of organic compound contaminants. A residual of the oxidization process is sulfate (SO₄⁻) as can been seen in equation 1. Equations 2-4 show the various persulfates (sodium, potassium, and ammonium) being initially broken down into the appropriate element and persulfate prior to the persulfate breaking down into sulfate.

S₂O₈²⁻→2SO₄⁻ (Eq. 1)

Na₂S₂O₈²⁻→2Na⁺+S₂O₈²⁻→2SO₄⁻ (Eq. 2)

K₂S₂O₈²⁻→2K⁺+S₂O₈²⁻→2SO₄⁻ (Eq. 3)

(NH₄⁺)₂S₂O₈²⁻→2NH₄⁺+S₂O₈²⁻→2SO₄⁻ (Eq. 4)

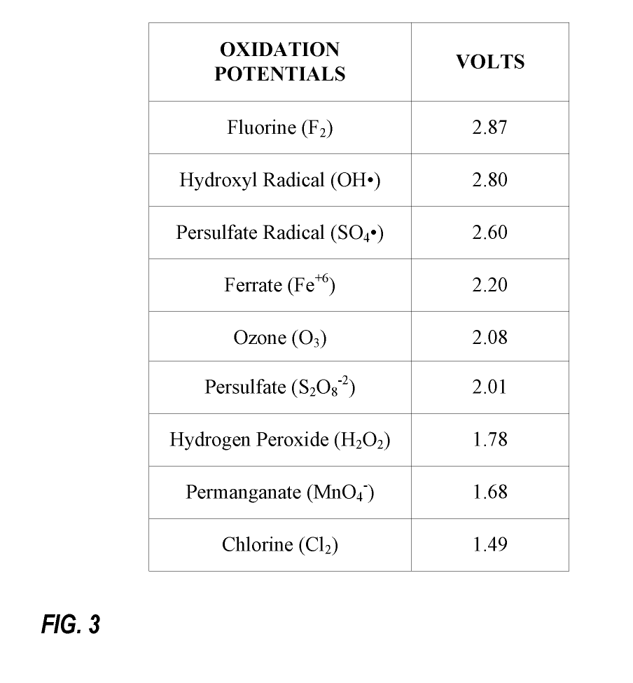

In addition to direct oxidation, the activation of the persulfate with the trivalent metal (e.g., ferric iron) forms sulfate radicals (SO₄.²) as seen in equation 5. This provides free radical reaction mechanisms similar to the hydroxyl radical pathways generated by Fenton's chemistry. The sulfate radicals are used to further oxidize the contaminants. In addition, the oxidation of the ferric iron further results into the generation of the highly unstable ferrate species of iron (Fe⁶⁺)) which can more effectively address the targeted contamination. The ferrate iron is a transient species that has elevated oxidation potential compared to other oxidants. FIG. 3 is a table that shows the elevated oxidation potential of the ferrate iron compared to other oxidants.

S₂O₈⁻+Fe⁺³→Fe^{(+4 to +6)}+SO₄⁻²+SO₄.⁻² (Eq. 5)

The chemical oxidation of the contaminants is followed by biological attenuation. The biological attenuation utilizes the byproducts of the chemical oxidation process (the sulfate formed and the residual ferric iron). The sulfate ion produced as a consequence of the decomposition of the persulfate allows for the attenuation of the targeted contaminants under sulfate reducing conditions. In addition, the iron present in the subsurface provides terminal electron acceptors for continued biological attenuation. As such, the term “biological attenuation” as used herein refers to degradation of compounds using biological processes and consequently the reduction of substances regarded to be contaminants in the substrate being treated.

After dissolved oxygen has been depleted in the treatment area, sulfate (by-product of the persulfate oxidation) may be used as an electron acceptor for anaerobic biodegradation. This process is termed sufanogenesis or sulfidogenesis and results in the production of sulfide. Sulfate concentrations may be used as an indicator of anaerobic degradation of fuel compounds. Stoichiometrically, each 1.0 mg/L of sulfate consumed by microbes results in the destruction of approximately 0.21 mg/L of BTEX. Sulfate can play an important role in bioremediation of petroleum products, acting as an electron acceptor in co-metabolic processes as well. The basic reactions of the mineralization of benzene (C₆H₆), toluene (C₇H₈) and xylenes (C₈H₁₀) under sulfate reduction are presented in equations 6-8 respectively.

C₆H₆+3.75SO₄⁻²+3H₂O→0.37H⁺+6HCO₃⁻+2.25HS⁻+2.25H₂S⁻ (Eq. 6)

C₇H₈+4.5SO₄⁻²+3H₂O→0.25H⁺+7HCO₃⁻+1.87HS⁻+1.88H₂S⁻ (Eq. 7)

C₈H₁₀+5.25SO₄⁻²+3H₂O→0.125H⁺+8HCO₃⁻+2.625HS⁻+2.625H₂S⁻ (Eq. 8)

Ferric iron is also used as an electron acceptor during anaerobic biodegradation of many contaminants after sulfate depletion, or sometimes in conjunction therewith. The basic reactions of the mineralization of benzene, toluene and xylenes using ferrous iron are presented in equations 9-11. During this process, ferric iron is reduced to ferrous iron (Fe⁺²), which is soluble in water. Ferrous iron may then be used as an indicator of anaerobic activity. As an example, stoichiometrically, the degradation of 1 mg/L of BTEX results in the production of approximately 21.8 mg/L of ferrous iron.

C₆H₆+18H₂O+30Fe⁺³→6HCO₃⁻+30Fe⁺²+36H⁺ (Eq. 9)

C₇H₈+21H₂O+36Fe⁺³→7HCO₃⁻+36Fe⁺²+43H⁺ (Eq. 10)

C₈H₁₀+24H₂O+42Fe⁺³→8HCO₃⁻+42Fe⁺²+50H⁺ (Eq. 11)

Ferrous iron formed as a result of the use of the ferric species as a terminal electron acceptor, under the same conditions the residual sulfate is utilized as a terminal electron acceptor by facultative organisms, generates sulfide (2S⁻²). Together, the ferrous iron and the sulfide promote the formation of pyrite (FeS₂) as a remedial byproduct as seen in equation 10. Equation 11 provides a more complete equation identifying where the ferrous iron and the sulfide come from. The reduction of ferric iron to ferrous iron readily supplies electrons to exchange and react with the sulfide. The pyrite is an iron bearing soil mineral with a favorable reductive capacity.

Fe⁺²+2S⁻²→FeS₂ (Eq. 10)

2Fe₂O₃+8SO₄²⁻→FeS₂+19O₂ (Eq. 11)

Pyrite possesses a finite number of reactive sites that are directly proportional to both its reductive capacity and the rate of decay for the target organics. Pyrite acts as a tertiary treatment mechanism under the reducing conditions of the environment. The reductive capacity of iron bearing soil minerals (like pyrite) initially results in a rapid removal of target organics by minimizing the competition between contaminants and sulfate as a terminal electron acceptor. Preventing these unfavorable interactions with ferric iron provides a continual source for electron exchange resulting in the timely removal of contaminants through pyrite suspension.

The mechanism described herein combats the toxic effects of sulfide and hydrogen sulfide accumulation on the facultative bacteria, while also providing a means of removing target organics through soil mineral (pyrite) suspension.

Once the reductive capacity of pyrite is met, the bound organic contaminants tend to precipitate out, removing the contaminants rapidly and without the production of daughter products.

The amount of tri-valent metal that should be utilized based on the amount of persulfate that is utilized can be calculated. Referring back to equations 2-4 shows that each persulfate molecule forms two sulfate molecules. We can determine the amount of sulfate that will be generated per amount of a specific persulfate by plugging the molecular weights into the equations.

The molecular weight are as follows: sodium persulfate (238 g), potassium persulfate (270 g), ammonium persulfate (228 g) and sulfate (96 g). Accordingly, 238 g of sodium persulfate, 270 g of potassium persulfate or 228 g of ammonium persulfate yields 192 g (2*96) of sulfate. Stated differently, approximately 1.24 g of sodium persulfate, 1.4 g of potassium persulfate or 1.19 g of ammonium persulfate is required to produce 1 g of sulfate. We can refer to these ratios as equations 2A-4A respectively.

Plugging molecular weights into equation 11 we can determine the amount of pyrite generated. The molecular weights are as follows: Fe₂O₃ (160 g), SO₄²⁻ (96 g) and FeS₂ (120 g). Accordingly, 320 g (2*160) of Fe₂O₃ and 768 g (8*96) of SO₄²⁻ creates 480 g (4*120) of FeS₂.

Using molecular weights we can calculate that 224 g of ferric iron (Fe³⁺) is required to produce the 320 g (2*160) of Fe₂O₃.

Utilizing equations 2A-4A, we can calculate that 952 g of sodium persulfate, 1080 g of potassium persulfate and 912 g of ammonium persulfate are required to produce 768 g of sulfate.

Accordingly, in order to produce the pyrite (e.g., 480 g) one would need to use 224 g of ferric iron and either 952 g of sodium persulfate, 1080 g of potassium persulfate or 912 g of ammonium persulfate. Simplifying the amount of the various persulfates to 100 g results in 23.53 g of ferric iron required per 100 g of sodium persulfate (23.53%), 20.74 g of ferric iron required per 100 g of potassium persulfate (20.74%) or 24.56 g of ferric iron required per 100 g of ammonium persulfate (24.56%). That is, for any of the three types of persulfate discussed one would want to utilize a molecular weight of ferric iron that is between approximately 20-25% of the molecular weight of the persulfate. So a mixture of ferric iron and persulfate would be between approximately 80% (100 g of persulfate/(100 g of persulfate+25 g of ferric iron)) to 83.3% (100 g of persulfate/(100 g of persulfate+20 g of ferric iron)) by weight of persulfate.

If we assumed a 25% range for the values of ferric iron, the amount of ferric iron would be between 17.65%-29.41% for sodium persulfate, 15.56%-25.93% of potassium persulfate or 18.42%-30.7% of ammonium persulfate.

Persons skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Although the invention has been illustrated by reference to specific embodiments, it will be apparent that the invention is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

1. A method for chemical oxidation followed by a biological attenuation process of an environmental medium containing one or more contaminants, the method comprising:
introducing a persulfate and one or more trivalent metals into the environmental medium, wherein the one or more trivalent metals activate the persulfate in order to chemically oxidize the one or more contaminants, wherein amount of the persulfate is selected to chemically oxidize the one or more contaminants and amount of the one or more trivalent metals is between approximately 20-25% of molecular weight of the persulfate so that at conclusion of the chemical oxidation sufficient residual sulfate and sufficient residual trivalent metals remain such that:
naturally occurring facultative cultures utilize the residual sulfate and the residual trivalent metal as terminal electron acceptors to promote the biological attenuation process of the one or more contaminants; and
the residual sulfate and the residual trivalent metal prevent formation and accumulation of hydrogen sulfide which is a toxin to the facultative cultures.

2. The method of claim 1, wherein the introducing one or more trivalent metals includes introducing the one or more trivalent metals via temporary or permanent wells.

3. The method of claim 1, wherein the introducing the persulfate includes introducing the persulfate via gravity feeding, induced gas stream, a pump, or a combination thereof.

4. The method of claim 1, wherein the introducing one or more trivalent metals includes introducing the one or more trivalent metals under pressure in either a gas or liquid stream.

5. The method of claim 1, wherein the persulfate and the one or more trivalent metals are combined before introduction into the environmental medium.

6. The method of claim 1, wherein the persulfate and the one or more trivalent metals are introduced into the environmental medium sequentially.

7. The method of claim 1, wherein the trivalent metal is ferric iron.

8. The method of claim 1, wherein the persulfate is sodium persulfate.

9. A method for oxidizing and biologically attenuating contaminants in an environmental medium containing one or more contaminants, the method comprising:
introducing a composition including persulfate and one or more trivalent metals into the environmental medium, wherein the one or more trivalent metals activate the persulfate in order to cause oxidation of the one or more contaminants, wherein the oxidation of the one or more contaminants provides residual material, and wherein an amount of the persulfate is approximately 80-83% and an amount of trivalent metal is approximately 17-20% of a molecular weight of the composition so as to produce sufficient residual material such that:
naturally occurring facultative cultures utilize the residual material as terminal electron acceptors to promote the biological attenuation process of the one or more contaminants; and
the residual material prevents formation and accumulation of a toxin to the facultative culture.

10. The method of claim 9, wherein the introducing one or more trivalent metals includes introducing the one or more trivalent metals via temporary or permanent wells.

11. The method of claim 9, wherein the introducing the persulfate includes introducing the persulfate via gravity feeding, induced gas stream, a pump, or a combination thereof.

12. The method of claim 9, wherein the introducing one or more trivalent metals includes introducing the one or more trivalent metals under pressure in either a gas or liquid stream.

13. The method of claim 9, wherein the persulfate and the one or more trivalent metals are combined before introduction into the environmental medium.

14. The method of claim 9, wherein the persulfate and the one or more trivalent metals are introduced into the environmental medium sequentially.

15. The method of claim 9, wherein the trivalent metal is ferric iron.

16. The method of claim 9, wherein the persulfate is sodium persulfate.
